(19) United States
(12) Patent Application Publication
(10) Pub. No.: US 2012/0260740 A1
(43) Pub. Date: Oct. 18, 2012

(54) STRAP WITH INTEGRATED SENSORS TO MEASURE TENSION

(76) Inventor: Dustin Colin Huguenot, Bowling Green, KY (US)

(21) Appl. No.: 13/450,412

(22) Filed: Apr. 18, 2012

Related U.S. Application Data
(60) Provisional application No. 61/476,396, filed on Apr. 18, 2011.

(51) Int. Cl. G01N 3/08

(52) U.S. Cl. 73/826

(57) ABSTRACT

A strap has one or more built-in sensors. The strap may be used, for example, in trucking, for securing loads inside a trailer or on the bed of a trailer. The sensors may wirelessly transmit tension data to a portable electronic device, such as a smart phone. This allows a user to monitor the tension on one or more straps without having to physically examine them.

### CROSS-REFERENCE TO RELATED APPLICATIONS

This application claims the benefit of priority of U.S. provisional patent application No. 61/476,396, filed Apr. 18, 2011, the contents of which are herein incorporated by reference.

### BACKGROUND OF THE INVENTION

The present invention relates to straps and, more particularly, to straps containing sensors inside it to measure tension and send that information to a smart phone or other indicator.

When applying straps to secure a load, it can be difficult to know if the strap is adequately securing the load without physically examining it. Conventional tension measuring devices are separate devices that need to be attached in-line with the strap, creating an additional connection, additional pieces and a connection point that could disconnect or loosen.

Current strapping can be tightened about a load, however, if that load shifts or the straps loosen, there is no way to know this without physically viewing the scrap.

As can be seen, there is a need for a strap having built-in sensors to measure the tension in the strap and send that tension information to a smart phone or other data receiving device.

### SUMMARY OF THE INVENTION

In one aspect of the present invention, a strap comprises one or more sensors integrated into the strap and adapted to measure tension applied to the strap; one or more batteries integrated into the strap and electrically connected to the one or more sensors; and one or more transmitters adapted to receive tension data from the one or more sensors and send the tension data to an electronic data receiving device.

In another aspect of the present invention, a method for monitoring tension in a strap comprises disposing at least one sensor integrally in the strap, the sensor adapted to receive power from at least one battery and measure tension of the strap; electrically connecting the at least one sensor to at least one transmitter, the transmitter receiving tension data from the at least one sensor; and receiving the tension data on an electronic receiving device.

These and other features, aspects and advantages of the present invention will become better understood with reference to the following drawings, description and claims.

### BRIEF DESCRIPTION OF THE DRAWINGS

FIG. 1 is a perspective view of a strap with built-in sensors according to an exemplary embodiment of the present invention; and

FIG. 2 is a perspective view of a strap tension data receiving device according to an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a strap having one or more built-in sensors. The strap may be used, for example, in trucking, for securing loads inside a trailer or on the bed of a trailer. The sensors may wirelessly transmit tension data to a portable electronic device, such as a smart phone. This allows a user to monitor the tension on one or more straps without having to physically examine them.

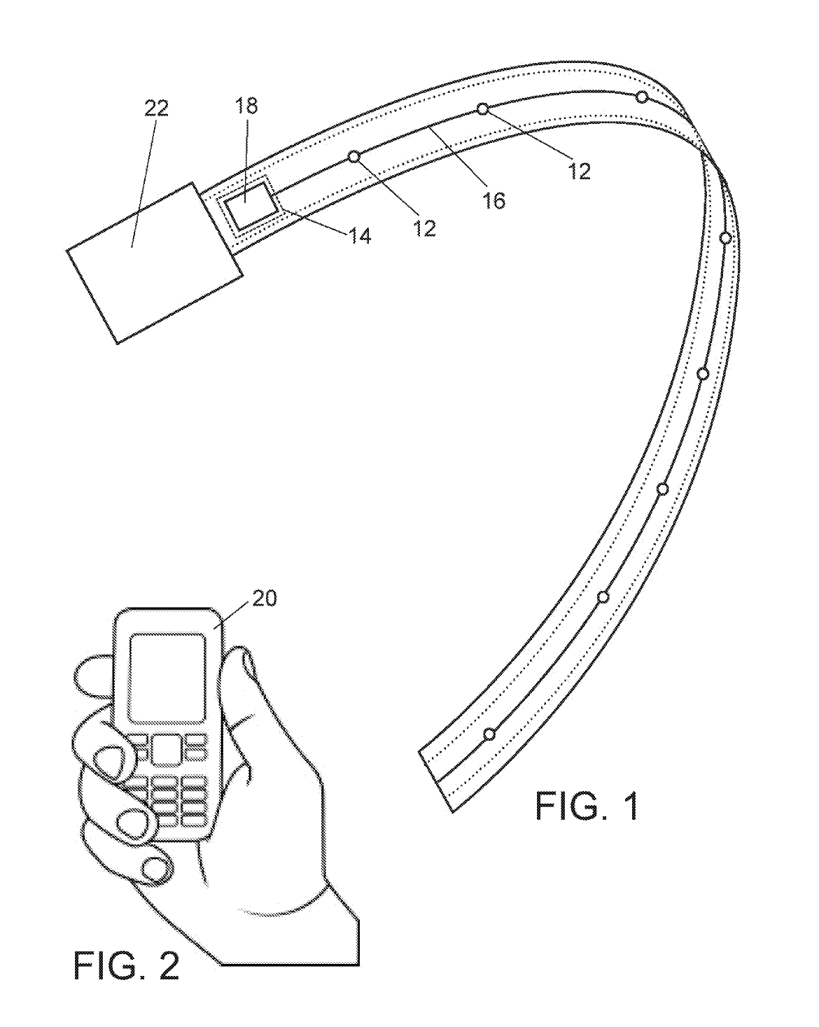

Referring to FIGS. 1 and 2, a strap 10 may have one or more sensors 12 built into the strap 10 to measure the tension of the strap 10. The sensors 12 may be powered by one or more batteries 14. The sensors 12 may be electrically interconnected with, for example, a wire 16. The wire may carry power to the sensors 12 from the batteries 14 and may also carry measured data from the sensors 12 to a transmitter 18. The transmitter 18 may send a signal that includes sensor data to a wireless device 20, such as a smart phone.

A strap hook 22 may be used to secure the strap 10. Other strap securing means, as may be known in the art, may be used to secure the strap in place.

The strap 10 may include a solar cell (not shown) that can be used to charge the batteries 14. This may be especially useful when the strap is used on an open bed trailer to secure a load.

The sensors 12 may be, for example, a plate sensor disposed in a box at one or more locations along the strap 10. Other sensor designs, as may be known in the art, may be used to detect the tension in the strap.

As described above, the transmitter 18 may send a data signal to the electronic device 20. The electronic device 20 may include software adapted to receive this signal and convert the signal into a sensor data display. The software may also include an alerting mechanism to alert the user (such as a truck driver) if one of the sensors detect tension below a predetermined minimum. The software may be designed to continually monitor the sensor tension data. In some embodiments, the transmitter 18 may only send a signal when the tension drops below the predetermined minimum. The electronic device 20 may be a smart phone, tablet computer, laptop computer, or a dedicated device adapted to receive the tension data from the sensors.

While the drawings show a single battery and a single transmitter, in some embodiments, there may be multiple batteries and/or multiple transmitters.

In some embodiments, there may be a single battery and transmitter for each sensor. In this embodiment, if a single sensor fails due to battery power or the transmitter, one or more of the other sensors on the strap may continue to operate.

While the above describes straps for securing loads, the straps of the present invention may be used for various other purposes. For example, the straps may be used for carrying or lifting an object or load.

It should be understood, of course, that the foregoing relates to exemplary embodiments of the invention and that modifications may be made without departing from the spirit and scope of the invention as set forth in the following claims.

What is claimed is:

1. A strap comprising:
one or more sensors integrated into the strap and adapted to measure tension applied to the strap;
one or more batteries integrated into the strap and electrically connected to the one or more sensors; and
one or more transmitters adapted to receive tension data from the one or more sensors and send the tension data to an electronic data receiving device.

2. The strap of claim 1, further comprising multiple sensors integrated at multiple locations along the strap.

3. The strap of claim 1, further comprising a strap hook disposed at one end of the strap.

4. The strap of claim 1, wherein the electronic data receiving device is a smart phone.

5. The strap of claim 4, wherein the smart phone includes software, written in computer code and stored on a computer readable medium, wherein the software include a code segment to receive the tension data and create an alert if the tension data indicates that tension in the strap is below a predetermined minimum.

6. The strap of claim 3, wherein at least one of the one or more transmitters are disposed on the strap adjacent to the strap hook.

7. A method for monitoring tension in a strap, comprising:
disposing at least one sensor integrally in the strap, the sensor adapted to receive power from at least one battery and measure tension of the strap;
electrically connecting the at least one sensor to at least one transmitter, the transmitter receiving tension data from the at least one sensor; and
receiving the tension data on an electronic receiving device.

8. The method of claim 7, further comprising creating an alert if the tension data is below a predetermined minimum.

9. The method of claim 7, wherein the electronic receiving device is a smart phone.

10. The method of claim 7, wherein a single transmitter receives tension data from the at least one sensor and sends the tension data to the electronic receiving device.
